(19) United States
(12) Patent Application Publication
(10) Pub. No.: US 2023/0000109 A1
(43) Pub. Date: Jan. 5, 2023

(54) PLANT BASED FOOD PRODUCT

(71) Applicants: DUPONT NUTRITION BIOSCIENCES APS, COPENHAGEN K (DK); DUPONT NUTRITION USA, INC., WILMINGTON, DE (US)

(72) Inventors: FLORIAN NETTESHEIM, Copenhagen K (DK); Dorthe Stenbaek, Copenhagen K (DK); Thomas Moeller Hansen, Copenhagen K (DK); Therese Fjaereide, Sandvika (NO)

(21) Appl. No.: 17/781,736

(22) PCT Filed: Dec. 2, 2020
(86) PCT No.: PCT/EP2020/084305

§ 371 Date: Jun. 2, 2022

(30) Foreign Application Priority Data
Dec. 2, 2019 (EP) 19212945.0

(51) Int. Cl. A23J 3/22; A23J 3/16; A23L 29/212; A23L 29/244; A23L 29/256; A23L 29/262; A23L 33/185; A23L 27/40

(52) U.S. Cl. CPC A23J 3/227; A23J 3/16; A23L 29/212; A23L 29/244; A23L 29/256; A23L 29/262; A23L 33/185; A23L 27/40; A23V 2002/00

(57) ABSTRACT

The present invention relates to a dry composition to produce a plant-based food product. The composition comprises a mixture of ingredients including carrageenan, cellulose ether, glucomannan, at least one plant-based protein, starch and Potassium chloride, to achieve desirable texture of the food product at uncooked, hot and cold conditions for optimal bite and juiciness. In addition, the invention also relates to the plant-based food product containing the composition and the process of producing the same.

### FIELD OF THE INVENTION

The present invention relates to a dry composition to produce a plant-based food product. The composition comprises a mixture of ingredients to achieve desirable texture of the food product at uncooked, hot or cold conditions for optimal bite and juiciness. In addition, the invention also relates to the plant-based food product containing the composition and the process of producing the same.

### BACKGROUND OF THE INVENTION

Plant-based meat substitute food products have enjoyed exceptional popularity in recent years due to the trends of increased vegetarianism and veganism. These trends are supported by scientific data reporting and suggesting that by moving to a predominantly plant-based diet individuals can make a significant contribution to mitigating the negative effects of climate change (Springmann, M.; Charles, H.; Godfray, J.; Raynor, M.; & Scarborough, P.; 2016, PNAS “Analysis and Valuation of Health and Climate Change Cobenefits of Dietary Change”, doi.org10.1073/pnas.1523119113). These authors move on to conclude that significant climatic benefits purport from humans consuming on average 15% less calories whilst increasing fruit and vegetable consumption by 25% with a concomitant reduction of meat by 56%. In a further paper Springmann et al (2018) report that changing to a more plant-based diet could result in significant reductions in climatic greenhouse gases (Marco Springmann at al, “Options for keeping the food industry within environmental limits.” (2018), Nature, 562, 519-525).

Thus, nowadays, the industry is experiencing a rapid expansion within this burgeoning field, and this invention contributes to solutions offering discerning consumers the option of positively impacting the climate around them.

Sausage is a main processed product of the meat industry it's production dating back centuries. Nowadays, sausage manufactures are increasingly pursuing improvement of plant-based sausages where textural parity with traditional products; such as smooth surface and section, high oil and water retention, no cracking during cooking, and organoleptic quality, such as high chewiness and hardness, high springiness, high cohesiveness and low adhesiveness are highly sought after and becoming a pre-requisite for successful product launches. Their other concern is maintaining the quality parity while avoiding spiraling manufacturing costs.

U.S. Pat. No. 4,348,420 relates to a process for binding comminuted meat in the presence of a water soluble dairy protein, such as alkali metal caseinates, and a hydrocolloid. The hydrocolloid is selected from the group consisting of alginate, carrageenan, guar, acacia, locust bean gum, carboxymethyl cellulose and carboxymethyl starch. A combination of a cellulose ether with one or more natural gums is not taught. The problem underlying U.S. Pat. No. 4,348,420 was to avoid fall-off in yield after extensive chopping in dairy-protein containing comminuted meat.

An article in “MEAT REASEARCH” (2008. 10. pages 28-30) by Fu Qiangquan et al. reports a blend of carrageenan and konjac gum being successfully used as a sausage additive to improve texture. However, the hardness or bite of the sausage was insufficient.

EP13873302 relates to a combination of cellulose ether and natural gums useful as sausage additive, more specifically as a binder for sausage-type meat products.

Despite the mentioned solutions related to meat-based products, its direct application into plant-based food products is not obvious, since fibrous structure provided by the fat and meat protein influences directly into the desirable texture of the food product at uncooked, hot and consumption temperature conditions for optimal bite and juiciness.

In US2002142086, vegetable sausage analogues are provided which have texture and flavor delivery components dispersed within a set-up matrix formed from a composition including powdered vegetable protein. The vegetable protein powder (soy isolates in example 1 and soy concentrate in example 2) in combination with egg albumin in the continuous phase is further combined with a filamentous discontinuous phase also called carbohydrate crumble (starch and water). In this solution, egg white is the only binder, which is not considered a solution for vegans.

In the patent application US2005003071A1 plant-based meat analogues are processed by sequentially blending methyl cellulose in ice/water mix, then blending in modified gluten and highly soluble vegetable protein in water and instigating gelling with mild heating, and oil to make an emulsion phase, and a modified starch. This is filled in casings and cooked. The obtained product described in this document would have inferior properties in uncooked and cooled states as it only contains methyl cellulose as binder, which only forms gels when heated. It means that when the sausage cools down to the temperature of consumption, the gel softens and the bite in the final product is lost.

The problem underlying the present invention is to provide a solution which improves the quality of plant-based sausage in terms of texture and organoleptic properties whilst simplifying the manufacturing process and avoiding further cost.

In the present invention the desirable texture in uncooked, hot and temperature of consumption is obtained. The invention provides a simplified, user-friendly, one step process, in which only water, oil and optionally seasoning are added together with the invented mix in one process step.

### OBJECT OF THE INVENTION

The object of the present invention is to provide a composition for producing an improved plant-based food product. The unique combination of the ingredients not only provides a single system minus oil water and flavorings, which when combined with these additional components provides a sausage dough but does so in a manner that removes the need for egg white protein, thus creating a truly vegan sausage product with desired sensory profile.

### BRIEF DESCRIPTION OF THE DRAWINGS

FIG. 1. PCA-Biplot of ingredient combinations screening for the egg-free binding solution. Triangles represent the gel strength property axes in this multivariate analysis, circles represent the score of the samples in the respective property.

FIG. 2. Gel strength of select samples at 5, 85, 5 and 60° C. measured in succession.

FIG. 3. Gel strength of select samples compared to commercially available samples measured at 5, 85, 5 and 60° C. measured in succession.

FIG. 4. Sensory evaluation of bite and juiciness by JAR scale of select samples.

### DETAILED DESCRIPTION OF INVENTION

The present invention is based on studies described herein which surprisingly demonstrate exceptional good quality of the composition described to produce a plant-based food product. The composition comprising:
a. Carrageenan;
b. Cellulose ether;
c. Glucomannan
d. Plant-based protein;
e. Starch;
f. Potassium chloride.

In the preferred embodiment of the invention the carrageenan is kappa carrageenan in an amount between 1.1 and 5.4%, preferably 2.0-3.8% by dry weight of the composition.

In the preferred embodiment of the invention the cellulose ether is methylcellulose in an amount between 0.5 and 10%, preferably 1-7% by dry weight of the composition.

In the preferred embodiment of the invention the glucomannan is konjac gum in an amount between 0.7 and 3.6%, preferably 1.3-2.5% by dry weight of the composition.

In another embodiment of the invention, carrageenan and konjac gum are present in a ratio of 3:2 and 9:1 carrageenan and konjac to potassium chloride.

The plant-based protein component is selected from the group of soy protein, gluten, potato protein, pea protein or combination thereof.

In an embodiment of the invention, the plant-based protein is a combination of soy protein in an amount of 30-50%, preferably 36-44% by dry weight of the composition.

In an embodiment of the invention, gluten is in an amount of 0-50%, preferably 34-38% by dry weight of the composition.

In one of the embodiments of the invention, the plant-based protein further contains potato protein in an amount between 0 and 10%, by dry weight of the composition.

In one of the embodiments of the invention, the plant-based protein further contains pea protein in an amount between 0 and 10%, by dry weight of the composition.

In the preferred embodiment of the invention the starch in an amount of 5-15%, preferably 9-11% by dry weight of the composition.

In the preferred embodiment of the invention the potassium chloride in an amount of 0.2-1.0%, preferably 0.4-0.7% by dry weight of the composition.

In one of the embodiments of the invention, the composition further comprises citrus fiber in an amount between 0 and 8%, preferably 2-7% by dry weight of the composition.

The composition may further comprise a fermentate in an amount of 0-2% which can be optionally added to improve the flavor profile.

### Definitions of the Ingredients

a. Carrageenan/Processed Eucheuma Seaweed (PES):

Component (a) of the edible components is carrageenan. Carrageenan is obtained by extraction with water or extraction and modification in dilute aqueous alkali of strains of seaweeds of the class Rhodophyceae (red seaweeds) with genus Eucheuma, Gigarina, Furecellari and Chondrus crispus. Carrageenan consists chiefly of the potassium, sodium, magnesium and calcium sulphate esters of galactose and 3,6-anhydrogalactose polysaccharide. These hexoses are alternately linked α-1,3 and β-1,4 in the copolymer. The prevalent polysaccharides in carrageenan are designated as kappa, iota, lambda depending on the number of sulphate groups by repeating unit (i.e. 1,2,3 sulphate). Between kappa and iota there is a continuum of intermediate compositions differing in number of sulphates per repeat units of between 1 and 2. Modification during the process is such that no organic precipitant shall be used other than methanol, ethanol and propan-2-ol. The wording carrageenan is reserved for the non-hydrolysed or otherwise chemically degraded polymer. In the present edible composition, any type of carrageenan may be used, either alone or in admixtures with at least one other type. In preferred embodiments component comprises kappa carrageenan.

PES is processed Eucheuma Seaweed which is modified but not extracted. It is commonly known as semi-refined carrageenan, and as such contains a higher proportion of insoluble matter than conventional carrageenan. Eucheuma seaweed. In the present edible composition both carrageenan and PES can be used or a combination of the two. In the preferred embodiment component comprises carrageenan.

a. Cellulose Ether:

Component (b) of the edible composition according to the present invention is cellulose ether. Examples of useful cellulose ethers include C₁-C₃-alkyl celluloses such as methyl cellulose, C₁-C₃-alkyl hydroxy-C₁-C₃-alkyl celluloses such as hydroxypropyl methylcellulose, hydroxyethyl methylcellulose, and ethyl hydroxyethyl cellulose; hydroxy-C₁-C₃-alkyl celluloses such as hydroxyethyl cellulose and hydroxypropyl cellulose; and mixed hydroxy-C₁-C₃-alkyl celluloses such as hydroxyethyl hydroxypropyl cellulose. In the preferred embodiment component comprises Methylcellulose (MC).

A preferred MC for use in the present invention has an average degree of substitution DSmethyl of from 1.2 to 2.0, more preferably from 1.5 to 1.9 and most preferably from 1.7 to 1.9. Typically, viscosities of 2% by weight aqueous MC solutions at 20° C., determined with a Ubbelohde tube viscometer, range from 40 to 140.000 mPa·s, preferably from 10.000-130.000 mPa·s, and more preferably from 70.000-120.000 mPa·s. Examples of commercially available MCs that are useful in the present invention include METHOCEL™, A, SGA, Bind, E, K, and G series; especially preferred is METHOCEL™ Bind 250—(DSmethyl=1.8, 2% by weight viscosity=95.000 mPa·s), all METHOCEL grades being available from DuPont.

b. Glucomannan

Component (c) of the edible composition is glucomannan, a polysaccharide that consists of D-glucose (G-unit) and D-mannose (M-unit) in a proportion of 5:8 joined by 1β→4 linkages. The basic polymeric repeating unit has the pattern: GGMMGMMMMMGGM. Short side chains of 11-16 monosaccharides occur at intervals of 50-60 units of the main chain attached by 1β→3 linkages. Also, acetate groups on carbon 6 occur at every 9-19 units of the main chain. Preferably, the glucomannan for use in the present invention is non-coagulated, i.e. it is preferably not alkali treated. Konjac gum obtained from tubers of Amorphophallus konjac is a specific example of a glucomannan, other examples are tubers of corm, salep. After refining, the konjac gum as commercially available may still contain water and other components. Typically, the konjac gum for use in the present invention comprises at least 40% by weight or at least 50% by weight or at least 60% by weight or at least 70% by weight or at least 80% by weight or at least 90% by weight or at least 92% by weight of glucomannan, each based on the weight of the konjac gum.

c. Plant-Based Protein

By plant-based protein we mean protein not stemming from pesco-, ovo-, lacto- or traditional animal meat-based sources. Plant-based proteins tend to have lower values of the essential amino acids such as leucine, isoleucine and valine, and consequently fail to trigger or promote muscle protein synthesis to the same degree. Additionally, antinutritional factors are also predominantly higher when compared with animal-based sources. However, although these components work to reduce ultimate digestibility of proteins, consumption of a balanced variety of plant-based protein does not place negative constraints on dietary efficacy. Indeed, these antinutritional factors can be mitigated by various procedures moving from germination techniques through fermentation and simple soaking of the plant material within standard culinary practice.

In terms of protein quality, soy protein is one of the few plant-based proteins which has a Protein Digestibility Corrected Amino Acid Score (PDCAAS) at parity with traditional meat sources.

In a preferred embodiment, component (d) of the edible composition is a combination of soy protein and gluten.

Soy protein is produced from dehulled and defatted soybean meal, which is processed into three kinds of high protein commercial products: soy flour, concentrates, and isolates Grinding soybeans to a fine powder results in soy flour, where three categories are prevalent: whole or full-fat, which contains natural oils; defatted, where the oil is removed and the protein content is 50%, and either high or low water solubility versions are available; and a lecithinated verion is also standard, i.e. where lecithin is added to the soy.

Soy protein concentrate (SPC) has a higher soy content, typically around 70%, and in broad general terms is simply defatted soy flour minus the water-soluble carbohydrates. Retaining much of the fibre of the original soybean and SPC examples are routinely used baked goods, breakfast cereals and significantly here, also in meat—and meat alternative products, where its function is to increase water and fat retention as well as enhance nutritional values.

Soy Protein Isolate (SPI) has the highest degree of ‘soy’ purity of all the soy products and holds a minimum soy content of 90%. Also produced from the soy flour it additionally has all the non-protein components removed, and this credits it with a neutral flavour characteristic. SPI products can be used to improve the texture of meat, and meat analogue products as well as increasing the protein content and fortification of the application, whilst retaining moisture and possessing emulsifying properties.

All soy types are widely used as functional or nutritional ingredients in a wide variety of food products. Here, soy protein concentrate and soy protein isolate are the most common advocates for this invention's purpose, albeit the preferred version here is soy protein isolate.

Wheat gluten belongs to a group of proteins, called prolamins and glutelins, which occur within starch in the endosperm of various cereal grains. It is found in related wheat species and hybrids, (such as spelt, khorasan, emmer, einkorn, and triticale), barley, rye, and oats. Prolamins in wheat are called gliadins; in barley, hordeins; in rye, secalins; and in oats, avenins, which are collectively referred to as gluten. Wheat glutelins are called glutenin. True gluten is limited to these four grains. Wheat Gluten is the major protein component of wheat and is obtained as the left over after removal of starch. In foods it is predominantly used to impart elasticity and texture.

d. Native Starch (Maize)

Component (e) in the edible composition is starch or amylum is a polymeric carbohydrate consisting of numerous glucose units joined by glycosidic bonds (α(1→4) and α(1→6)). It consists of two types of molecules: the linear and helical amylose α(1→4) linkages and the branched amylopectin with α(1→4) and α(1→6) linkages. This polysaccharide is produced by most green plants as energy storage. It is the most common carbohydrate in human diets and is contained in large amounts in staple foods like potatoes, wheat, maize (corn), rice, and cassava. Pure starch is a white, tasteless and odorless powder that is insoluble in cold water or alcohol. Depending on the plant, starch generally contains 20 to 25% amylose and 75 to 80% amylopectin by weight.

Citrus Fiber.

An optional component in the present composition is citrus fiber which is derived from the byproduct of juice production. The pulp and peel of the citrus fruit left over during juicing are mechanically treated and dried to obtain a powder in which the tightly bound soluble components and insoluble fibrous material are loosened, the surface area enhanced and thus the product is activated. This material contains raw native pectin, hemicellulose and protein which impart this product with its functionality. Citrus fibers possess high water holding capacity, build viscosity and can form gels. Furthermore, citrus fiber has emulsification properties. The addition of citrus fiber also improves the texture and taste of final products, help with suspension and emulsion stabilization. Citrus fibers are neutral in taste, flavor and odor, they are also low in fat and digestible carbohydrates with a low calorie content.

Potato Protein, Patatin

Another optional component in the present composition is potato proteins are a constituent part of potato tubers, found at levels of typically about 1 but as high as 11% in special varieties. They are normally isolated from potato fruit juice (PFJ), a side stream of the starch production process. Potato proteins are classified into three types: 1. protease inhibitors (7-21 kDa, 40% of protein) 2. patatin (40-42 kDa, 50% of protein), and 3. higher molecular weight species. Patatin, the major fraction of potato protein, is a glycoprotein with about 50% glycosylation with isoelectric points between 4.5 and 5.2. It serves as a storage protein with unique functionality, structure (35% alpha helicies, 45% beta strands and 15% aperiodic) and bioactivity. It has an amino acid composition quite similar to egg-white (ovalbumin) and whey protein, where charged and uncharged amino acids are distributed randomly along the sequence, and the tertiary structure consists of α-helical and β-sheet sections, which successively unfold upon heating. In food formulations it is used to impart functionality such as foam stabilization, emulsification and heat induced gelation.

In other embodiments of the composition, a fermentate could be optionally added in other to improve the flavour profile. Fermentates can be based on many substrates, essentially anything that provides a fermentable source of carbohydrate; e.g. cane sugar skim milk powder or wheat starch etc. Here, in this embodiment though, a fermentate is understood to be a cultured dextrose, which is fermented, heat treated (or pasteurized) and spray dried before being partnered with a maltodextrin carrier.

The present invention also refers to the use of the described composition to produce a plant-based food product.

By plant-based food product it is meant a product which is a meat analogue, i.e., devoid of meat protein. Beyond that, the plant-based food product here will mimic taste, texture, smell and appearance of a similar meat-based product, offering the consumer a viable alternative to cut their meat intake and still deliver on gustatory satisfaction.

In a preferred embodiment of the invention, the plant-based food product containing the composition is sausage analogue.

The term “sausage” is directed to an edible product (food product) which requires processing into an emulsion, followed by shaping and heating to solidify the product to a stable physical form. In this emulsion system the continuous phase (matrix) is mainly composed of water and protein (primarily myosin coming from the meat), and further additives including those of the present invention and starch, if present, and the dispersed phase is fat or oil which is embedded in the matrix and stabilized by protein or other materials with surface activity. The matrix ties the fat and water tightly into the whole system. As a result, the sausage performance is mainly determined by the matrix (continuous phase). Although the term “sausage” generally relates to a food product having an approximately cylindrical shape, similar products having the shape of a non-specific loaf are also encompassed herein by the term “sausage”.

The term “plant-based sausage” conforms to the above definition with the exception of the protein stemming from the meat muscle myosin.

Finally, the present invention also refers to the method of production of the described food product, wherein the method comprises the steps of:
blend the described composition with ice water;
add rapeseed oil and sodium chloride;
optionally add seasoning.

In the method of production of the food product, as described above, the composition object of the invention is blended with ice water in an amount of 55-65% by total weight. Rapeseed oil in added in an amount of 9-19% by total weight and sodium chloride in an amount of 0-2% by total weight. Seasonings are added optionally by discretion.

### EXAMPLES

### I. Material and Methods

A first set of samples was prepared to screen a wide range of ingredients and determine those with the strongest influence on texture and bite of a sausage. The full list of ingredients is shown in Table 1. The samples listed in Table 2 were prepared by the listed ingredients at dry concentrations given in Table 3, together with soy protein isolate, wheat gluten, starch, to which sodium chloride, maltodextrin, rapeseed oil, ice-water, and optionally seasoning were then added into a high-speed mixer to prepare the plant-based meat-alternative dough.

TABLE 1
Raw materials

| Ingredient | Supplier |
|---|---|
| Soy protein isolate | DuPont |
| Methyl cellulose | DuPont |
| k-Carrageenan | DuPont |
| Alginate | DuPont |
| Fermentate | DuPont |
| Processed Eucheuma seaweed | DuPont |
| Pea fiber | DuPont |
| Potato fiber | Avebe |
| Bamboo fiber | Rettenmaier, Germany |
| Konjac | Mercury Enterprice Limited |
| Bamboo fiber | Rettenmaier, Germany |
| Wheat gluten | Kroner Starke |
| Citrus fiber | Fiberstar; USA |
| Corn Starch | Cargill |
| KCI | Klinge Chemical |
| Egg white protein | Sanovo Foods |

TABLE 2
Sample list for design of experiment ingredient screening

| Sample | |
|---|---|
| No. | Ingredients |
| 1 | Citrus fiber |
| 2 | Alginate/calcium/phosphate + pea protein + |
| | bamboo fiber |
| 3 | Alginate/calcium/phosphate + methyl cellulose + |
| | potato protein + bamboo fiber |
| 4 | Alginate/calcium/phosphate + potato protein + |
| | pea protein + citrus Fiber |
| 5 | Carrageenan/glucomannan/KCI + |
| | Alginate/calcium/phosphate + |
| | methyl cellulose + potato protein + pea protein + |
| | bamboo fiber |
| 6 | Carrageenan/glucomannan/KCI + |
| | Alginate/calcium/phosphate + |
| | methyl cellulose + pea protein + citrus fiber |
| 7 | Carrageenan/glucomannan/KCI + |
| | Alginate/calcium/phosphate + |
| | potato protein + citrus fiber |
| 8 | Carrageenan/glucomannan/KCI + potato protein + |
| | pea protein + bamboo fiber |
| 9 | Carrageenan/glucomannan/KCI + methyl cellulose + |
| | potato protein + citrus fiber |
| 10 | Alginate/calcium/phosphate+ methyl cellulose + |
| | citrus fiber |
| 11 | Methyl cellulose + pea protein + bamboo fiber |
| 12 | Potato protein + bamboo |
| 13 | Carrageenan/glucomannan/KCI + methyl cellulose + |
| | bamboo fiber |
| 14 | Methyl cellulose + pea protein + potato protein + |
| | citrus fiber |
| 15 | Carrageenan/glucomannan/KCI + pea protein + |
| | citrus fiber |
| 16 | Carrageenan/glucomannan/KCI + |
| | Alginate/calcium/phosphate + bamboo fiber |
| 17 | Egg white + gluten |

TABLE 3
Use levels for dry ingredients in table 2

| Ingredient | Use level in the dry blend [%] |
|---|---|
| Citrus fiber | 1.6 |
| Alginate/calcium/phosphate | 3.2 |
| Pea protein | 3.2 |
| Potato protein | 1.6 |
| Carrageenan/glucomannan/KCI | 3.2 |
| Methocel | 3.2 |
| Bamboo fiber | 3.2 |
| Egg white protein + Gluten | 16 |

A selection of ingredients from the ones describe in tables 2 and 3 was subsequently made. These samples, their ingredients and respective amounts are shown in table 4. The liquid phase consists of 82.7% of ice water and 16% of rapeseed oil and 1.3% of sodium chloride. The dry components are 36.4% of the soy protein, 36.4% of the wheat gluten and 9.1% of the starch in addition to the components listed in Table 4.

TABLE 4
Sample selection and ingredients in the compositions

| Sample No. | Additional components for the dry blend | Use level [%] |
|---|---|---|
| Sample 9 | Methylcellulose + | 3.2; 3.2; 1.6; 1.6 |
| | Carrageenan/glucomannan/KCI + | |
| | potato protein + citrus fiber | |
| Sample 42 | Pea protein + | 4.8; 4.8 |
| | Carrageenan/glucomannan/KCI | |
| Sample 43 | Methylcellulose + | 3.3; 3.3; 3.3 |
| | Carrageenan/glucomannan/KCI + | |
| | pea protein | |
| Sample 51 | Methylcellulose + | 5.5; 5.0 |
| | Carrageenan/glucomannan/KCI | |
| Sample 52 | Methylcellulose + | 5.0; 5.0; 2.2 |
| | Carrageenan/glucomannan/KCI + | |
| | citrus fiber | |
| Sample 53 | Methylcellulose + | 5.0; 5.; 8.8 |
| | Carrageenan/glucomannan/KCI + | |
| | potato protein | |
| Sample 55 | Methyl cellulose + PES carrageenan + | 4.3; 4.3; 1.0 |
| | potato protein | |
| Sample 56 | Potato protein + Citrus fiber | 6.6; 2.2 |
| Sample 58 | Methylcellulose+ | 5.0; 5.0; 8.8 |
| | Carrageenan/glucomannan/KCI + | |
| | pea protein | |
| Sample 71 | Commercial meat based fine | N/A |
| | emulsified sausage: | |
| | Fat, meat protein, potato starch, | |
| | soy protein | |
| Sample 72 | Commercial plant based fine | N/A |
| | emulsified sausage: | |
| | Pea Protein, Wheat Gluten, | |
| | Potato Starch, Sodium Alginate, | |
| | Methyl Cellulose, fermented | |
| | dextrose | |

The manufacturing of the sausage dough is done in a high-speed bowl chopper that can also apply vacuum. Then water/ice 1:1 is added. All dry ingredients are added during slow speed mixing at the bowl chopper and chopped for 2 min at high speed to make the plant-based sausage dough. Samples of this sausage dough were taken and 200 mL filled into containers for subsequent testing. Texture analysis was performed at four different temperatures successively. Gel strength was measured on a texture analyzer by Stable Micro Systems, United Kingdom. The plant-based sausage dough is successively tested at 4 temperatures: At cold storage temperature (5° C.), at high temperature (85° C.), again at cold storage temperature (5° C.) and finally at consumption temperature (60° C.).

The setting for the measurements were as follows:
trigger force: 2.0 g
pre speed: 1.0 mm/sec
post speed: 8.0 mm (sec
test speed: 0.5 mm/sec
distance: 10.0 mm
Mode:
measure mode. Compression
option: Return to start
unit select: Grams
test output: Peak\hat{ }
plunger: ½″ (TA5)

Processing

Sausages were prepared by the process described above, after which the sausage dough was filled into peeling casings which were steam cooked at 92° C. to the core temperature 85° C. Subsequently, the sausages were cooled to the core temperature 40° C. and packed into bags and transferred to a cooling room (4° C.) for storage.

The sausages were steam cooked at 92° C. again to prepare for sensory testing. Sensory tests evaluated the bite and juiciness at consumption temperature of about 60° C. The sensory test method is described below.

Sensory Test Method

The evaluation of sensory and visual characteristics of the sausages was conducted by a panel of nine assessors using the just about right scale. Just about right (JAR) scales measure the appropriateness of the level of a specific attribute and are used to determine the optimum levels of attributes in a product. In consumer testing consumers are often asked whether a sensory characteristic of a product (e.g., saltiness) is too high, too low, or just about right.

There are many variations of JAR scales, we have used a scale of five, ranging from too weak to too strong for the bite and ranging from too dry to too juicy for juiciness of a plant-based sausage. One end point is labeled as “much too little”, the other end point as “much too much” and the middle point as “just about right”. There are many variations of JAR scales. Here is used a 5-point category scale where categories were labeled for the bite; too weak, slightly too weak, just about right, slightly too strong and too strong. For the juiciness we used too dry, slightly too dry, just about right, slightly too juicy and too juicy.

The compositions of the samples evaluated in the sensory tests are listed in table 3.

### II. Results and Comments

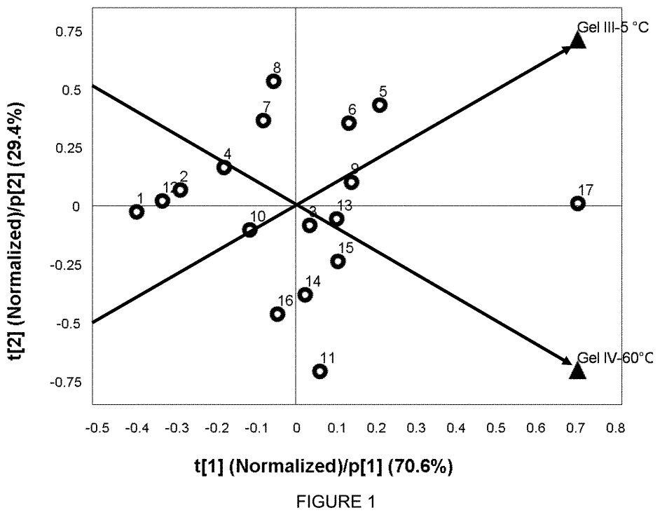

FIG. 1 shows the results of an initial screening of ingredients referenced to egg-white protein containing sausage (sample 17). It shows how different ingredients affect the gel strengths measured at two different conditions, namely cold storage (5° C.) and consumption temperature (60° C.). The gel strength of an egg white containing plant-based sausage is very high at both, refrigerated as well as consumption conditions. With the egg white containing sample as a reference a selection of ingredients can be made which improves gel strength and thus the bite at these different conditions. It can furthermore be learned that methyl cellulose influences both, the texture and consumption and storage temperature. The combination of carrageenan and glucomannan mostly increase the low temperature texture without adversely affecting texture at consumption temperature while methyl cellulose increases the texture at consumption temperature. Sample without methyl cellulose or carrageenan/glucomannan only affect gel strength at 60 or 5° C., respectively. Samples without either consistently negatively influence both properties. Only samples containing both, Methyl cellulose and a blend of Carrageenan, glucomannan and potassium chloride, increased the gel strengths at both 5 and 60° C. toward the value for the egg white containing product.

Such guidance in ingredient selection is relevant since these solutions target not only vegans and vegetarians, but also flexitarian. It is thus important that the plant-based protein product can mimic taste, texture, smell and appearance of meat. For this, the combination of Carrageenan/Glucomannan with Methyl cellulose is necessary to provide both, hot and cold bite similar to what an egg white containing solution would feel like. The remaining ingredients, potato protein, pea protein and citrus fiber do not significantly lower any of the texture properties.

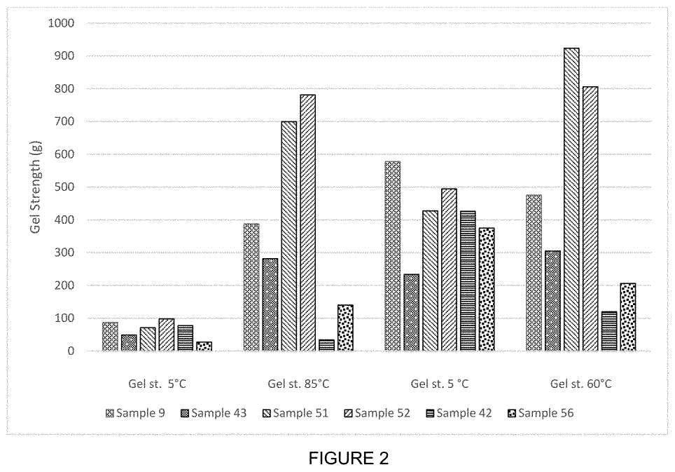

FIG. 2 shows results of gel strength measurements at 4 successively temperatures: At cold storage temperature (5° C.), at high cooking temperature (85° C.) during the production, again at cold storage temperature (5° C.) and finally at consumption temperature (60° C.) for samples 9, 42, 43, 51, 52 and 56. Their composition is listed in Table 3. Samples which develop a high gel strength after the cooking step (e.g. 85° C.) are suitable egg white replacements for plant-based sausage applications.

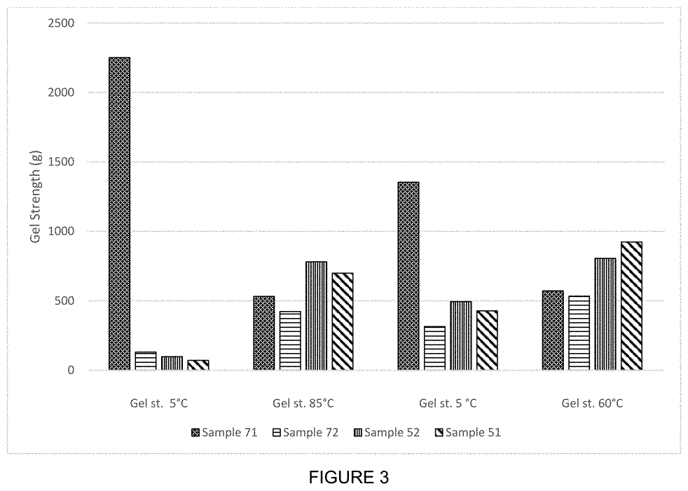

FIG. 3 shows a comparison of the best candidates selected from FIG. 2 with commercial samples. One of the commercial references is a meat-based sausage (71), the other a plant-based sausage (72) using a different binder system (see table 3). This highlights the strength of the embodiment in this invention over the plant-based incumbent and shows how closely the textural properties of a meat-based sausage are matched.

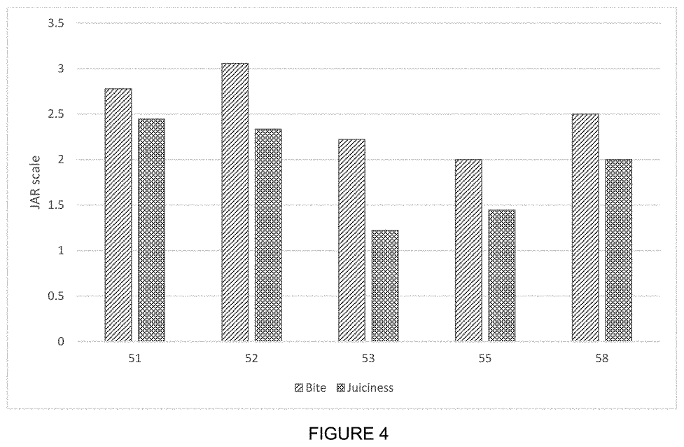

Sensory evaluations shown in FIG. 4 confirm significant improvements in bite and juiciness in various plant-based sausage samples as claimed in embodiments of the present invention.

1. A composition suitable for use in a plant-based food product comprising:
a) Carrageenan;
b) Cellulose ether;
c) Glucomannan;
d) Plant-based protein(s);
e) Starch; and
f) Potassium chloride.

2. The composition according to claim 1, wherein the carrageenan is kappa carrageenan in an amount between 1.1 and 5.4% by dry weight of the composition.

3. The composition according to claim 1, wherein the cellulose ether is methyl cellulose in an amount between 0.5 and 10% by dry weight of the composition.

4. The composition according to claim 1, wherein the glucomannan is konjac gum in an amount between 0.7 and 3.6% by dry weight of the composition.

5. The composition according to claim 1, wherein the weight ratio of carrageenan to konjac gum is 3:2 and the weight ratio of carrageenan and konjac to potassium chloride is 9:1.

6. The composition according to claim 1, wherein the plant-based protein is selected from the group consisting of soy protein, gluten, potato protein, pea protein and combination thereof.

7. The composition according to claim 1, wherein the plant-based protein comprises the plant based protein in an amount of 30-50% by dry weight of the composition and gluten in an amount up to and including 50% by dry weight of the composition.

8. The composition according to claim 1, wherein the plant-based protein comprises two or more proteins wherein one of the proteins is potato protein in an amount up to and including 10% by dry weight of the composition.

9. The composition according to claim 1 wherein the plant-based protein comprises two or more proteins wherein one of the proteins is pea protein in an amount up to and including 10% by dry weight of the composition.

10. The composition according to claim 1, wherein the starch is present in an amount of 5-15% by dry weight of the composition.

11. The composition according to claim 1, wherein the potassium chloride is present in an amount of 0.2-1.0% by dry weight of the composition.

12. The composition according to claim 1, wherein the composition further comprises citrus fiber.

13. The composition according to claim 12, wherein the citrus fiber in an amount up to and including 8% by dry weight of the composition.

14. The composition according to claim 1, wherein the composition comprises:
a. carrageenan in an amount of 2.0-3.8% by dry weight of the composition;
b. methyl cellulose in an amount of 1-7% by dry weight of the composition;
c. konjac gum in an amount of 1.3-2.5% by dry weight of the composition;
d. soy in an amount of 36-44% by dry weight of the composition;
e. gluten in an amount of 36-44% by dry weight of the composition;
f. starch in an amount of 9-11% by dry weight of the composition;
g. potassium chloride in an amount of 0.4-0.7% by dry weight of the composition;
h. citrus fiber in an amount of 2-7% by dry weight of the composition.

15. (canceled)

16. A plant-based food product, wherein the food product:
comprises the composition as defined in claim 1, and
is a sausage analogue.

17. A method of making the food product described in claim 16, wherein the method comprises blending the composition with:
water in an amount of 55-65% by total weight,
rapeseed oil in an amount of 9-19% by total weight, and
sodium chloride in an amount of 0-2% by total weight.
